(19) United States
(12) Patent Application Publication
(10) Pub. No.: US 2010/0047422 A1
(43) Pub. Date: Feb. 25, 2010

(54) PROCESS FOR ENRICHING THE AROMA PROFILE OF A DEALCOHOLIZED BEVERAGE

(76) Inventors: Adélio Miguel Magalhães Mendes, Porto (PT); Luis Miguel Palma Madeira, Pedroucos (PT); Margarida Dias Catarino, S. Mamede De Infesta (PT)

Correspondence Address: CERMAK KENEALY VAIDYA & NAKAJIMA LLP, 515 EAST BRADDOCK RD SUITE B, Alexandria, VA, 22314, US

(21) Appl. No.: 12/526,801

(22) PCT Filed: Feb. 11, 2008
(86) PCT No.: PCT/IB2008/050482

§ 371 Date: Aug. 27, 2009

(30) Foreign Application Priority Data
Feb. 12, 2007 (PT) 103657

(51) Int. Cl. A23L 2/56; C12G 3/08

(52) U.S. Cl. 426/494; 426/492

(57) ABSTRACT

The present invention concerns a process for enriching the aroma profile of beverages, especially beer and wine, by means of extraction, using pervaporation, of aromas from the original beverage and subsequent addition of the extracted aromas to the beverage, after total or partial dealcoholization. The original beverage (1) is fed to the membrane separation module (4) wherein the permeate side (5) is under vacuum, provided by a vacuum pump (12). The feed contacts with the membrane surface and the aromas are selectively permeated to the permeate side of the membrane, where they suffer evaporation. The vapor permeate stream (5) is condensed (10) at an appropriate temperature, which can be cryogenic. After the aroma extraction, the beverage (6) is fed to a dealcoholization unit (14) for obtaining a non-alcoholic drink (15), however depleted in aroma compounds. Finally, the extracted aromas (10) are added to the dealcoholized beverage, thus an aroma enriched product (16) being obtained without considerably increasing its alcohol content.

### BACKGROUND OF THE INVENTION

The present invention concerns the extraction/recovery of aroma compounds from an alcoholic beverage, such as beer or wine, for the subsequent addition to a beverage lacking on these compounds, and makes use of the pervaporation technology. Nowadays, pervaporation showed to be a highly promising process in the food industry for separating aroma compounds. It is a highly selective membrane separation process^{[1]}. Moreover, this process can be operated at low temperatures, in contrast with other processes such as distillation. This characteristic of pervaporation is an advantage when the objective is the separation of thermosensitive compounds^{[1-4]}, such as some aroma compounds of alcoholic beverages obtained by fermentation.

### PRIOR ART

The aroma recovery from juices or fermented beverages, such as wine or beer, is an increasingly important operation concerning the food processing industry. The aroma of beverages, such as juice, beer or wine, consists of a large group of volatile organic compounds (VOCs), which are responsible for the odor and taste of the beverage, and whose concentration levels are low, usually at the ppm level^{[1-4]}. These aroma compounds can belong to different chemical functional groups, such as alcohols, esters, aldehydes, lactones, carboxylic acids, phenols, ethers, etc.^{[2-3}]. Each group of aroma compounds is responsible for a typical odor and taste. Esters, for example, confer to the drink a sweet and fruity flavor, while aldehydes are associated to the freshness (immaturity) of the beverage. On the other hand, alcohols, which are the major group of aroma compounds in fermented drinks, such as beer and wine, where ethanol is the dominant one, provide an alcoholic, fruity and immature flavor^{[5]}.

During the past years it has been observed a significant increase in the low alcohol beverages market. This trend is due mainly to health and civil responsibility reasons. However, some of the non-alcoholic drinks available in the market have a limited acceptability by the consumers due to their lack in aroma compounds. In fact, products obtained by means of interrupted fermentation do not have the typical aroma profile of the alcoholic beverages. On the other hand, some dealcoholization processes submit the product to drastic conditions that might lead to the loss of the original aroma, which is the greatest contribution for its quality, and consequently for its acceptance by the consumers^{[4]}. The beverage processing, especially if carried out at high temperatures, can considerably modify the aroma composition. This modification can be due to physical losses and/or chemical reactions that change the original aroma compounds^{[1,2,6,7]}. As a consequence, the sensorial quality of the product can drastically differ from that of the initial beverage. So, the success of the dealcoholized beverages depends on the ability to reproduce the original aroma profile.

To overcome the modification of the sensorial profile of the beverages, it can be considered to recover the aroma compounds lost during the drinks processing for lowering the alcohol content, or to extract these aroma compounds before the dealcoholization heat-based process, and adding them subsequently to the final product. Presently, there are available several effective processes for this application, the membrane processes such as pervaporation being the most attractive. Besides its high selectivity, pervaporation can be carried out at low temperatures, which is suitable for the treatment of thermosensitive aromas^{[1-4]}. Moreover, pervaporation is a physical separation process, thus being favored by the international food legislation, having a low energetic consumption and not requiring any additives such as in solvent extraction^{[3,4,8,9]}. Besides these advantages, it is a process that allows the extraction/recovery of the original aromas, which have an important commercial value due to the natural, non synthetic, nature of the aroma compounds.

Pervaporation technology has been improved tremendously during the past decade, especially for dehydration applications, although being a process finding application in the separation of thermosensitive compounds, mixtures with azeotropes and isomers mixtures^{[10,11]}. In summary the applications of pervaporation can be divided in three main groups: a) dehydration of organic-aqueous mixtures; b) removal of organic compounds from aqueous solutions; c) separation of organic solvent mixtures. The first major industrial application of pervaporation was the dehydration of solvents, being still the most important application^{[11]}. For these applications hydrophilic membranes are required. The employment of pervaporation for removing organic compounds from aqueous solutions is also carried out at industrial level, but in minor extent^{[10]}, since it was developed more recently. This application requires the use of hydrophobic membranes. Lately, pervaporation has been largely used in chemical and petrochemical industries for the separation of organic mixtures^{[11]}.

Nowadays, one can observe an increase trend in the use of pervaporation for recovering aroma compounds in food applications, especially in the recovery and enrichment of aromas such as in fruit juices. The heat treatment processes of juices, such as pasteurization and mainly the conventional processes for juice concentration such as evaporation, cause the loss of the original aromas and as a result the loss of quality of the processed products^{[1,6,7]}. Besides the use of pervaporation in the fruit juice industry, its use has also been reported for aroma recovery from fermented beverages, such as beer or wine^{[4,12]}, due to the aroma loss that occurs during heat treatments of these beverages and even in dealcoholization processes.

Despite the numerous scientific publications referring the pervaporation use in the aroma recovery from alcoholic beverages, there are no references reporting the use of pervaporation as disclosed in the present invention. The core of the present invention concerns obtaining an aroma concentrate to be added to an aroma-depleted beverage, e.g. a partially or totally dealcoholized beer, in order to obtain a beer with an aroma-enriched profile and for example similar to the original beer. This operation mode differs from the ones previously disclosed.

U.S. Pat. No. 4,792,402 (December, 1988) discloses a process for concentrating alcoholic drinks, by means of dehydration using reverse osmosis, in order to reduce the transport costs due to the large contribution of water content in the beverages. This document corresponds to EP 0116462 of August 1984, which was also worldwide disclosed in August 1984 WO 84/03102. In this process, the original beer is submitted to reverse osmosis, where the membrane is permeable to water and might be partially or totally permeable to ethanol and aroma compounds. The retentate from the reverse osmosis—the concentrated beverage—can or not be recycled to the feeding tank, according to the operation mode—batch or continuous, respectively. In order to not significantly change the beverage aroma profile, the permeate stream from the reverse osmosis, which is mostly water, is led to a distillation unit (under vacuum) for separating ethanol and the aroma compounds. The distillation column can consists of a typical column or a packed column, comprising a vapor striping bottom section and a rectification top section, wherein the permeate stream is fed at the intersection of the sections. The permeate flows down through the striping section. At the bottom it boils and the vapor flows up through the striping section absorbing ethanol and aromas from the descending permeate. Next, the vapor containing alcohol and aromas continues flowing up, through the rectification section, where the fractional distillation takes place. The said vapor leaves the column with a little amount of water and, after condensation, is added to the concentrated beverage. The beverage can finally be reconstituted with deaerated water up to the desired concentration (amount of ethanol and density). This process differs from the one reported in the present invention, mainly because patent U.S. Pat. No. 4,792,402 employs distillation for recovering aroma compounds, while in the present invention a pervaporation process is employed. The main target of U.S. Pat. No. 4,792,402 patent is the concentration of alcoholic beverages by water removal, to make their transport easier, whereas the present invention targets the aroma enrichment of a dealcoholized beverage.

U.S. Pat. No. 5,030,356 (July, 1991) describes a process for recovering organic compounds from liquid streams. This method combines two separation processes: pervaporation and decantation. A continuation in part of that patent—U.S. Pat. No. 5,169,533—was submitted in December 1992. Later, in November 1993, a new patent was submitted—U.S. Pat. No. 5,266,206—as a continuation in part of the previous one. The process reported in these patents concerns the separation and recovery of organic compounds from industrial liquid effluents. The choice of the operation mode depends on the nature of the feeding stream. If the feed is an aqueous solution with a small organic concentration, forming a single-phase solution, it is advantageous to use pervaporation first. In this embodiment, the permeate stream from the pervaporation unit contains an organic concentration above the water solubility and then forms two phases which are separated (after condensation) in a decanter. The aqueous phase, typically saturated in organic(s) compound(s), is recycled back to the pervaporation unit. When the feed stream comprises two phases, it is first fed to the decanter, for separating the phases, the aqueous phase being fed to the pervaporation system. The leaving permeate stream forms two phases and is recycled back to the decanter. In both embodiments two streams are formed: an aqueous stream with residual concentration of organic compounds and a high-purity concentrated organic stream that might be recovered and reused. In this invention, the solutions that are intended to be treated can be industrial effluents or wastewater from food or beverage processing, containing aromas, essences or other organic compounds. This process is especially useful to treat streams from evaporators, used for concentrating fruit juices (such as apple juice), which have aroma compounds that contribute to the juice flavor and taste. After the treatment, the organic phase, whose aroma concentration is very high, can be added to the juice or, on the other hand, it can be used in the aroma and fragrances industries. This process differs from the one herein disclosed, mainly because the objective of patent U.S. Pat. No. 5,266,206 is the recovery of organic compounds (e.g. aromas) from an industrial aqueous effluent, while the present invention consists on the extraction of aroma compounds from a main stream for adding them back to the same stream, after dealcoholization. On the other hand, in patent U.S. Pat. No. 5,266,206 an aqueous and an organic streams are formed, which does not occur in the present invention.

U.S. Pat. No. 5,263,409 (November, 1993) discloses a membrane separation process for removing bitter agents from citrus juice, without significantly changing the amount of important nutritional compounds. The method consists of the separation through two membrane contactor modules, where the compounds are transferred between streams by means of selective membranes. In the first module, the bitter agents permeate a semi permeable membrane, from the juice to an extractor fluid (e.g. organic fluid). This enriched fluid is fed to a second membrane contactor, wherein the bitter agents permeate a second membrane and are hydrolyzed (from carboxylic acids to esters) by a second fluid, which flows in the opposite side of the membrane. This stream becomes depleted in these compounds and is recycled to the first module to flow along the permeate side. The bitter removal is carried out up to the desired level, the important nutritional elements (such as the ascorbic acid) being kept in the citrus juice once the first membrane is impermeable to these compounds. This process (U.S. Pat. No. 5,263,409) is different from the present invention since two membrane contactors are used for extracting and removing undesirable compounds (bitter agents).

U.S. Pat. No. 5,308,631 (May, 1994) discloses a process for producing non-alcoholic beer and concentrated beer aroma by means of adsorption with hydrophobic adsorbents and subsequent distillation of the extracted phase. This document corresponds to EP 0486345 of October 1991. The process is based on co-adsorption of ethanol and aroma compounds in hydrophobic adsorbents, such as zeolites. As a result, an aqueous eluant and an adsorbed phase are formed. The second part of the process consists on separating the aqueous phase from the adsorbent, saturated with alcohol and flavors. In order to recover the later, desorption is required. After desorption, the desorbed phase is fed to a distillation unit where it is fractionated into a highly alcoholic stream and a concentrated aroma stream. Finally, the non-alcoholic beer is reconstituted by mixing the dealcoholized eluant with the aromatic extract and then pressurized with gaseous carbon dioxide. This process (U.S. Pat. No. 5,308,631) differs from the one described in the present invention mainly because it uses an adsorption process for extracting aromas followed by distillation for producing a low alcohol aqueous phase and an aroma concentrate for adding to the dealcoholized beer.

U.S. Pat. No. 5,385,647 (January 1995) discloses a process for producing a non-alcoholic beer by means of dealcoholization by pervaporation of a regular alcoholic beer. In this process, the pressure that is applied to the vacuum side of the membrane and the condenser temperature allow the selective permeation of ethanol over the aroma compounds. On the other hand, when the recovery of aroma compounds is required, a second condenser, working under extremer conditions (lower condensation temperature), is placed in series with the first one. In this embodiment of the invention the permeate from the second condenser is added to the retentate stream in order to overcome the loss of aroma compounds during the dealcoholization. This process (U.S. Pat. No. 5,385,647) is different from the one disclosed in the present invention since it targets the dealcoholization of beer, instead of the aroma extraction for subsequent addition to the beer after dealcoholization.

U.S. Pat. No. 5,817,359 (October, 1998) discloses a process based on membrane separation (perscraction with controlled absorption) for removing ethanol from fermented beverages. In this process the alcoholic brew contacts with the hydrophobic membrane surface. In the downstream side of the membrane a strip solution flows, in order to extract ethanol (and some aroma compounds) from the feed, resulting in an alcoholized strip solution and in a non-alcoholic product. In general, the strip solution consists of deaerated water and preferentially carbon dioxide saturated water, in order to avoid its transfer through the membrane and the consequent decarbonation of the beverage. In following dealcoholizations, at least a fraction of the dealcoholized beverage and/or a fraction of the strip solution obtained in the previous dealcoholization (since both streams contain aroma compounds) could be used as strip solution. Accordingly, the concentration of aroma compounds (excluding ethanol) in the strip solution side is kept high, minimizing the permeation through the membrane, since the driving force between both sides of the membrane is reduced. As a consequence, the aroma loss during this process is minimized. This process (U.S. Pat. No. 5,817,359) differs from the one reported in the present invention mainly because it uses a membrane contactor (dialysis) for dealcoholizing beverages, while in the present invention a pervaporation process, for extracting aromas and subsequent addition to the dealcoholized beverage, is proposed.

U.S. Pat. No. 6,162,360 (December, 2000) discloses a membrane separation process that uses dialysis for transferring the aroma compounds from a regular alcoholic beer to a commercial non-alcoholic beer. In July 2002 a new patent (U.S. Pat. No. 6,419,829) was filed as a continuation in part of the previous one. In this process the hydrophobic membrane, which might be a solid or liquid membrane, is placed between the feed solution and the stream that is intended to enrich (the pick-up fluid). In this case the feed stream corresponds to the solution from which the aroma compounds are extracted, such as a regular alcoholic beer available in the market. The pick-up fluid consists of a commercial non-alcoholic beer (e.g. produced by distillation or dialysis) with low or no aroma concentration. Hence, the aroma compounds permeate selectively the membrane, according to the concentrations profile, towards the beverage which is intended to improve. The separation process is carried out until the equilibrium within the aroma compounds concentration is achieved in both sides of the membrane. At the end of the process both beverages show the same aroma profile except for ethanol, whose membrane permeability is lower than for other aroma compounds, and consequently this profile is slightly less concentrated than the original beer profile. According to this invention, the feed solution can also be a beer containing undesirable compounds (such as ethanol, for instance), which can be extracted for a permeate such as water or carbon dioxide, in which the aromas are absorbed or solubilized, resulting in a beverage comprising the desirable aroma and depleted or exempt from undesirable aroma. So being, enriched drinks can be obtained, either by increasing the content in desirable aromas or by decreasing their undesirable contents, selecting for each case appropriated feeding streams and permeate pick-up fluids. This process (U.S. Pat. No. 6,419,829) diverges from the one described in the present invention, mainly because it employs a membrane contactor for dialysis of aroma compounds from an alcoholic and aroma-enriched beer into a non-alcoholic beer and thus depleted in aroma flavors, while the present invention proposes pervaporation for extracting aromas from the original alcoholic beer and its subsequent reincorporation in the same beer, after the dealcoholization process.

U.S. Pat. No. 6,287,618 (September, 2001) discloses a process for producing a concentrated citrus aroma and also citrus aromas and fragrances, using for this purpose an evaporation unit working under vacuum and distillation using a spinning cone column supplied by Flavourtech (U.S. Pat. No. 4,995,945). This unit is mainly used for the dealcoholization of drinks and aroma extraction. The process herein disclosed is used for producing a citrus aroma concentrate whose composition is suitable for being used as raw-material in the production of aromas and fragrances. The method for producing the concentrated aroma consists of concentrating up to 100 to 150 times the original juice, by continuous evaporation under vacuum. Next, a filtration step is carried out to separate the floating essential oil, which contains the aroma compounds, from the recovered solution. The remaining recovered solution of concentrated citrus is led to a spinning cone column in order to separate the aroma or flavor compounds. Finally, these compounds can be added to juices or desserts. This process (U.S. Pat. No. 6,287,618) is different from the present invention since it considers the aroma concentration of fruit juices by means of vacuum evaporation and vacuum distillation (using a spinning cone column).

U.S. Pat. No. 6,518,050 (February, 2003) discloses a process for producing aroma compounds from by-products of the fermented brews distillation, such as wine, and extracting the respective aroma by means of pervaporation. The PCT application of this patent was submitted on October 1999—WO 99/54432. Wine distillation yields by-products which contain many essential nutrients for growing microorganisms, such as yeasts, without ethanol or aromas, once these compounds are removed through the distillate. Microorganisms can produce compounds like aromas or fragrances based on wine distillation by-products as substrates and optimized growing conditions. Some available separation processes, such as pervaporation, might be used for extracting the valuable products from the culture medium. This process (U.S. Pat. No. 6,518,050) differs from the one disclosed in the present invention because it employs pervaporation in a completely distinct context, in particular the aroma extraction from one certain substrate, without having to reestablish the aroma balance of such substrate after dealcoholization. In the present invention, the pervaporation process is used for extracting aroma compounds from a main process stream (e.g. beer), which should be submitted to dealcoholization with consequent loss of its aroma profile and, after dealcoholization, the extracted aroma compounds are reincorporated in the dealcoholized beer.

U.S. Pat. No. 6,755,975 (June, 2004) discloses a process for separating mixtures containing water and organic compounds, using pervaporation and dephlegmation (reflux condensation) of the permeate, in order to improve the selectivity towards the more desirable compounds. In this invention, the feed solution (containing the compound to be extracted) goes to the pervaporation module. The membranes in this unit can be hydrophilic or hydrophobic, depending on the nature of the compounds to be removed. The permeate solution from the pervaporation step is sent, in the vapor phase, to the dephlegmator for partial condensation. The structure of that unit (such as packed columns) should be able to provide heat and mass transfer between the rising flowing vapor and sliding flowing condensate. By this way the overhead vapor product is enriched in the more volatile compound and the bottom condensate product is richer in the less volatile compound, depending on the desired separation. This method of partially condensating the permeate stream increases the separation of the most desired compounds. This process can be applied to the food industry, for processing beverages, such as juices, wine or beer; during extraction of aromas; or even in the ethanol continuous removal from the fermentation reactors, for avoiding the yeast inhibition due to high contents of ethanol in the fermentation broth. This process (U.S. Pat. No. 6,755,975) is distinct from the present invention since it employs pervaporation coupled to dephlegmation, while the present invention proposes pervaporation for extracting aroma compounds from a main stream that should be submitted to a dealcoholization process, and hence to an aroma profile loss. On the other hand, in the present invention, the extracted aromas are reincorporated in the original beverage after dealcoholization.

PT 102976 (June, 2004) discloses a process for reducing the ethanol content of beverages by means of nanofiltration, with subsequent alcohol removal from the permeate by distillation and its addition to the beverage to be treated, its corresponding PCT application having been filed in December 2004—WO 2004/113489. The disclosed process employs nanofiltration membranes for total or partial removal of ethanol from beverages. The resulting permeate (which is mainly water, ethanol and some salts) is sent to a distillation unit for ethanol removal. The bottom product (without ethanol) is added back to the nanofiltration beverage in order to keep its organoleptic characteristics. This process (PT 102976) differs from the one disclosed in the present invention mainly because it uses nanofiltration for wine dealcoholization and distillation for recovering the aroma compounds of the nanofiltration permeate stream. In contrast, the present invention proposes pervaporation for extracting aromas and subsequent addition to the original beverage, after dealcoholization.

### BRIEF DESCRIPTION OF THE INVENTION

The present invention discloses a process for complete or partial recovery of the original aroma profile of a beverage, submitted to a total or partial ethanol removal. This disclosed process employs the pervaporation technology for extracting the desired aroma compounds from the original beverage, which are added to the resulting beverage after dealcoholization, and thus depleted at the sensorial level.

In the mentioned process, the original alcoholic beverage (such as beer or wine, for instance) whose aroma compounds are intended to be extracted, is fed to the membrane separation module of the pervaporation unit. At the membrane module, a feed fraction selectively permeates through the membrane (aroma compounds) and evaporates when leaving the membrane at the permeate side, which is maintained under vacuum. The permeated aromas are collected after condensation in a heat exchanger. The condensation temperature should be low enough in order to avoid the loss of the most volatile aroma compounds, therefore should be lower than −80° C. and could be cryogenic (−196° C.). On the other hand, the permeate pressure should also be low enough to allow a high permeate flux and a selective permeation of the heaviest compounds. The permeate pressure should be between 100 Pa and 10 kPa, according to the application. The feed fraction that does not permeate the membrane (the retentate) leaves the membrane module and consists of a solution slightly depleted in the original aroma compounds. The retentate stream from the pervaporation unit could be recycled in order to extract therefrom the remaining aroma compounds, or instead it might be sent to a dealcoholization system in order to obtain the dealcoholized beverage to which it is intended to add the concentrated aroma.

The aroma profile of the extracted compounds can be adjusted by tuning the operation and design conditions of the process. These conditions comprise the membrane thickness and composition, which affect mainly the permeate flux and the aroma compounds permselectivity, respectively; the feed temperature, once it influences the membrane permeability towards different aroma compounds and the driving force of chemical species through the membrane, as a consequence of their evaporation ratio after permeation (because the vapor pressure in the permeate side is also affected); the feed flow rate, which should be high enough in order to minimize the concentration polarization; and the vacuum pressure that is applied at the permeate side, which affects the selectivity and the permeate flux, although the effect of the permeate pressure on the aroma selectivity shows different behaviors according to the compounds' volatility—the permeation selectivity towards the more volatile aroma compounds increases with the permeate pressure increase (less vacuum), while it decreases in the case of the heaviest compounds. Concerning the membrane flux and in the absence of permanent dissolved gases, the permeate flow rate depends mainly on the feed temperature and on the permeate pressure, increasing with the first operating variable and decreasing with the second one. On the other hand, the retentate pressure has a slight influence on the membrane flux and selectivity. In the presence of dissolved permanent gases, such as carbon dioxide, the temperature increase leads to a higher amount of gas desorption. Consequently, the pressure on the permeate side might increase due to head losses and/or limitations of the vacuum pump. The condensation temperature is also a critical factor on the process and hence it should be carefully selected, once it should allow the total or partial condensation of the most desired aroma compounds.

In general one can say that:

a) the membrane should be as thin as possible for increasing the productivity, but not too thin in order to avoid the deterioration of the selectivity due to swelling and in order to keep the mechanical strength;

b) the feed temperature should be as high as allowed by the beverage sensitivity, since it leads to a productivity increase due to the exponential increase of the membrane flux with temperature; on the other hand, it should be as low as possible in order to balance the selectivity towards the most desired compounds, such as high-alcohols and esters, against ethanol, taken that in POMS (polyoctylmethylsiloxane) membranes supported in PEI (polyetherimide), a temperature increase leads to an increase of high-alcohols concentration on the permeate side compared to ethanol and, consequently, high-alcohols selectivity increases with temperature; on the other hand, in the esters concentration a decrease in the permeate concentration is observed, as well as a selectivity decrease, as temperature rises;

c) the feed flow rate should be high enough in order to guarantee a turbulent flow regime over the membrane surface for minimizing the concentration polarization;

d) the permeate pressure should be as low as possible, in order to increase the productivity, but not too low, in order to reduce the vacuum costs; on the other hand, the lower the permeate pressure the higher amounts of heavy compounds (such as amyl-alcohols) will be recovered. According to this, the condensers should have little head loss in order to keep the permeate side of the membrane modules at sufficiently low pressure, driven by the vacuum pump. The vacuum ducts, mainly the ones from the modules until the condensers (where the volume flow rate is very high) should be designed in order to keep the head loss very small;

e) the condensation temperature should be as low as possible to maximize the aromas condensation and to reduce the vacuum costs, but not too low because of the cooling costs; on the other hand, the lower the condensation temperature, the higher the concentration of light aromas on the final product.

Finally, it was observed that composite membranes made of POMS (polyoctylmethylsiloxane) supported in PEI (polyetherimide) show good selectivity and permeability towards the key beer aroma compounds.

Hence, according to the proposed in the present invent, the aroma compounds, such as high-alcohols and esters, which have the highest contribution to the aroma profile of fermented alcoholic beverages, can be selectively permeated through a hydrophobic membrane using a pervaporation process. As a result, a high concentrated permeate of aroma compounds is obtained, whose ratio towards the origin beverage might be of tens, in the case of high-alcohols, or hundreds, in the case of esters. The permeate can be added to the dealcoholized beverage, thus depleted from aroma compounds, in order to improve its sensorial quality, without significantly increasing its ethanol content. The aroma concentrate volume that is needed to be added to the beverage represents a small fraction of the total volume.

### BRIEF DESCRIPTION OF THE DRAWINGS

The present invention discloses a process for obtaining an aroma concentrate by means of pervaporation of a beverage with regular ethanol content. This concentrated aroma is intended to be added to an aroma-depleted profile beverage, such as a dealcoholized beer, in order to produce a non-alcoholic beer (ethanol content less than 0.5% v/v) with good organoleptic characteristics.

FIG. 1 represents a flow diagram of an industrial pervaporation unit for extracting beer aroma compounds and a dealcoholization unit, which can also include a treatment step of the dealcoholized beverage, whose aroma content is compensated with a permeate stream from the pervaporation unit. The set-up comprises a feed stream or original beverage connection (1); a feeding pump (2); a feed heat exchanger (3); a set of pervaporation membrane modules (4); a connection of the permeate vapor stream, from the modules (5); a connection of the feed fraction that does not permeate de membrane—the retentate (6); two condensers sets (7 and 8); a circulator (9); a connection of the condensed permeate (10); a tank for collecting the permeate in liquid state (11); a vacuum pump (12); a dosing pump (13); a dealcoholization system (14), which can include a final treatment system; a dealcoholized drink stream connection (15); a final product stream connection (16); a heat water connection (17); a cooling fluid connection (18), and a vacuum pump vent (19) through which the non-condensable compounds are vented.

### DETAILED DESCRIPTION OF THE INVENTION

The present invention discloses a process for producing non-alcoholic or low-alcoholic beverages, such as beer or wine, with an enriched aroma profile, which might be similar or not to the original alcoholic beverage profile.

Therefore, it is assumed that an original beverage, whose alcohol concentration is above the target value, is submitted to a process for total or partial removal of its ethanol content. This alcohol removal process causes the loss of a more or less important fraction of the beverage aroma compounds.

The present invention also describes a process for the complete or partial recovery of the aroma profile of the original beverage.

This process is based on the pervaporation of the original beverage, aiming at extracting aroma compounds and the subsequent addition to the dealcoholized drink.

1. Extraction of the Aroma Compounds.

The original alcoholic beverage is sent to the membrane separation module of the pervaporation unit, where it tangentially contacts with the selective membrane surface.

The membranes used in this application are composite membranes, where the selective film has a thickness between 0.1 and 2 μm, and where the selective layer can be made of polydimethylsiloxane (PDMS) or polyoctylmethylsiloxane supported in polyetherimide (POMS/PEI).

According to the targeted aroma profile for the permeate, the original beverage can be heated from 5 to 40° C., before the membrane pervaporation module inlet. The permeate side is kept under vacuum being the pressure in this side preferentially in the range between 100 Pa and 10 kPa.

In the pervaporation process described, the original beverage is usually fed to the membrane modules at atmospheric pressure or at a slightly higher pressure, such as 0.4 MPa absolute.

2. Permeate Recovery.

The permeated aroma compounds leave the membrane in the vapor phase and are collected, after condensation, in a system of heat exchangers set in parallel that operate alternate to each other to allow the semi-continuous collection of the aroma permeates.

In the condenser system, a pair number of heat exchangers working in alternated mode are used. One set of condensers is used for condensing the volatile compounds of the permeate stream during half of the cycle, while the other set of condensers is cut from the vacuum and heated, up to a temperature which is high enough to allow defrosting and collecting the volatile condensates.

The condensation temperature should be lower than −80° C. and could be cryogenic (−196° C.). In this case, a couple of two condensers, working at extremer conditions, should be placed in series with the previous condenser system, in order to allow the condensation of the more volatile fraction of the original beverage aroma profile.

3. Recovery of the Non-Permeable Feed Fraction.

The non-permeated feed fraction (retentate) leaves the membrane module and consists of a slightly depleted solution on the extracted aromas.

The recycling of a retentate fraction can be important in order to increase the flow velocity of the liquid stream over the membrane surface, allowing a negligible concentration polarization. Under these conditions, the retentate stream can be used as a second feed solution in order to recover its remaining aroma compounds.

On the other hand, the retentate flow from the pervaporation unit is directed to a dealcoholization set-up in order to produce the respective dealcoholized beverage and to which the aroma concentrate is to be added.

4. Dealcoholization of the Beverage.

Depending on the embodiment of the present invention, the original beverage, from which the aroma compounds are extracted by means of pervaporation, can be fed to a dealcoholization unit.

The alcohol removal process can be provided by means of countercurrent flow contact between the beverage and steam under vacuum or by means of reverse osmosis. During beverage processing, alcohol is continuously removed through the vapor phase, a non-alcoholic drink or a low-alcoholic drink being obtained, depending on the targeted requirements for the final product.

During the dealcoholization process most of the compounds which are essential to the beverage aroma/flavor balance are usually lost. In these conditions the addition of aroma compounds is required.

5. Enrichment of the Beverage in Aromas.

The permeate stream from the pervaporation unit is an aqueous solution enriched in the aroma compounds of the original alcoholic beverage. After condensation and defrosting provided by the condenser system, operating in alternated mode, the permeate solution is collected in an intermediate tank before its addition to the dealcoholized beverage, at the end of the process. The aroma extract is added directly to the dealcoholized beverage stream through a dosing pump that feeds the exact quantity of permeate which is needed to enrich the beverage.

This aroma quantity represents a small fraction of the beverage total volume, and is selected according to the aroma profile that is intended, and according to the requirements of ethanol limits that are allowed by the legislation for the final beverage.

### Example 1

Extraction of Aroma Compounds from a Regular Alcohol Content Beer using a Lab Pervaporation Unit

The original beer (alcohol content around 5.5% v/v), stored in the feeding tank, is sent to a membrane module, with an effective membrane area of 107.46 cm². The membranes used are flat POMS composites with a thickness of about 1.5 μm, supported in a porous layer of PEI. The feed stream is pumped by means of a centrifugal pump. Before entering in the membrane module, the feed stream is fractioned and a portion thereof is recycled back to the feeding reservoir, through a plate heat exchanger (effective area of 20 dm²). The other feed fraction is directed to the membrane module and the aroma compounds selectively permeate through the membrane, wherein the driving force results from the sub-atmospheric pressure by means of a vacuum pump with a nominal minimum vacuum pressure of 0.2 Pa and a maximum water vapor flow rate of 0.22 kg·h⁻¹.

The permeate leaves the membrane in the vapor phase and is condensed in a cold-trap, immersed in liquid nitrogen. The cold-trap consists of two concentric cylinders made of stainless steel, specifically designed for this application, the cold-trap being placed in an isolated dewar flask filled with liquid nitrogen, at −196° C. (in order to allow the complete condensation of the aroma compounds, even the most volatile ones). The cold-trap connects with the membrane module and with the vacuum pump downstream by means of stainless steel flexible tubes. All these tubes are attached by clamp type connectors for easier disconnection and permeate collection. The aromas are collected from the cold-trap after defrost, which can be carried out by immerging it in glycol-water mixture at about 0° C., in order to avoid the loss of the most volatile aroma compounds. After defrosting, the aromas are collected in glass flasks.

The fraction of the beer that is fed into the module, and which does not permeate the membrane, leaves the module through the retentate exit and is also recycled back into the feeding tank, through the plate heat exchanger. The retentate flow rate is measured using a rotameter and is controlled by needle valves.

The feed pressure is read using a manometer, placed at the module's inlet, and is regulated by needle valves. This feed arrangement allows independently adjusting the feed/retentate flow rate and the pressure of the first stream.

The permeate flow rate is gravimetrically measured after the predetermined permeation time has finished. The downstream pressure (permeate side) is monitored by a pressure sensor/transmitter and is adjusted by tuning a diaphragm valve.

Feed temperature was maintained at ca. 5° C. and the absolute pressure at about 0.4 MPa. The permeate pressure was kept at about 100 Pa. This lab set-up allows the production of an aroma concentrate such that, when added to a dealcoholized beer (0.0% v/v of ethanol), produced by a spinning cone distillation column, allows obtaining a final beer with less than 0.05% v/v of ethanol (so-called 0.0% alcohol beer) and with an aroma-enriched profile. The added amount of concentrated aroma was about 0.4% and the final beer presented an aroma composition similar to the original one, mainly in esters composition, whose profile is totally recovered. Moreover, a sensorial analysis to the product, made by a restrict group of tasters, recognized a good aroma profile and taste, similar to the original beer.

### Example 2

Industrial Production of a Non-Alcoholic Beer from an Alcoholic Beer with Reincorporation of Original Aroma Compounds

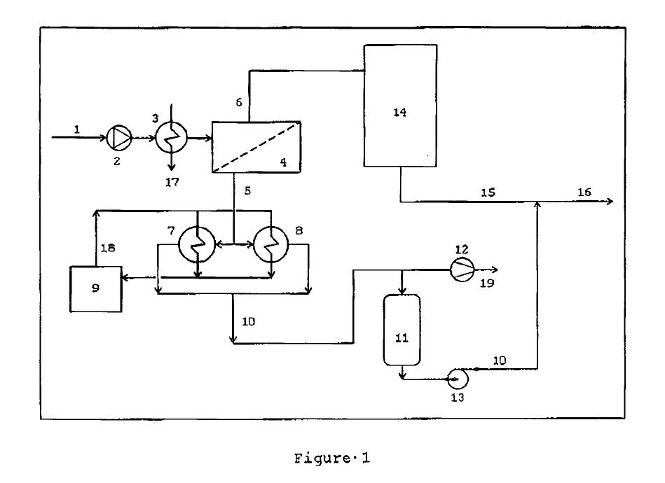

The original beer (1), from which it is intended to extract the aroma compounds, is a concentrated beer with about 6% v/v alcohol content and with a residual carbon dioxide content (around 3.8 g·l⁻¹). The beer is fed into the membrane module (4), with an effective area of 40 m² of composite POMS supported in PEI membrane. The transfer of the original beer to the module is made by a centrifugal pump (2) at an absolute pressure of 0.25 MPa, in order to keep a maximum pressure drop of 0.2 MPa between the feed and retentate sides of the module. The feed flow rate is 20 hl·h⁻¹. Before entering the separation module, the beer might be heated from 5 to 40° C., in order to increase the membrane productivity and to improve the selectivity towards the most desired compounds. In order to warm the beer stream and keep it at a stable temperature, water can be used in constant circulation inside the heat exchanger (3) (FIG. 1).

On the permeate side of the membrane module, pressure is kept under atmospheric pressure (100 Pa to 10 kPa) by means of a rotary vane vacuum pump (12). The vacuum allows the mass transfer of the aroma compounds from the feed to the permeate side and subsequent evaporation of the same in this side of the membrane. The permeate stream in vapor phase (5), containing high concentrations of aroma compounds, is fed into the first set of condensers (7). A circulator machine (9) supplies a cooling fluid (18), at −80° C., to the condensers, for condensing the permeate. The above-mentioned system of condensers (7) operates in an alternated mode with the second set of condensers (8), in order to allow the semi-continuous recovery of aromas. A second condenser system, working at extremer temperature conditions, can be placed in series on the permeate line, in order to guarantee the complete condensation of the aromas which did not condense on the previous condensers (7 and 8). A cryogenic fluid, such as liquid nitrogen at −196° C., might be used on the last condenser. The non-condensable compounds, such as carbon dioxide, are expelled through the vacuum pump vent (19).

Once condensed, the permeate stream (10) is stored in a tank (11). The permeate discharge is carried out by means of a dosing pump (13), which sets the aroma compounds flow rate (about 8 l·h⁻¹) that is needed to be added to the final beer.

The feed fraction (6) that does not permeate the membrane—retentate—corresponds to a slightly depleted beer in aromas. This stream is fed into the dealcoholization unit (14) wherein a beer with an alcohol content of less than 0.5% or even less than 0.05% by volume is obtained.

At the end of the process, the permeate from the pervaporation unit is added, after condensation (10), to the dealcoholized beer (15), once during the ethanol removal process most of the volatile aroma compounds are lost together with ethanol. So being, a non-alcoholic beer (16) is obtained, which mostly preserves the flavor profile from the original beer.

### BIBLIOGRAPHY

EP 0116462—‘Concentration of alcoholic beverages’, August 1984;

WO 8403102—‘Concentration of alcoholic beverages’, August 1984;

U.S. Pat. No. 4,792,402—‘Concentration of alcoholic beverages’, December 1988;

U.S. Pat. No. 4,995,945—‘Counter-current gas-liquid contacting device’, February 1991;

U.S. Pat. No. 5,030,356—‘Process for recovering organic components from liquid streams’, July 1991;

EP 0486345—‘Process of making alcohol-free beer and beer aroma concentrates’, October 1991;

U.S. Pat. No. 5,169,533—‘Process for recovering organic components from liquid streams’, December 1992;

U.S. Pat. No. 5,263,409—‘Membrane extraction of citrus bittering agents’, November 1993;

U.S. Pat. No. 5,266,206—‘Process for recovering organic components from liquid streams’, November 1993;

U.S. Pat. No. 5,308,631—‘Process of making alcohol-free beer and beer aroma concentrates’, May 1994;

U.S. Pat. No. 5,385,647—‘Process for the reduction of the alcohol content of alcoholic beverages’, January 1995;

U.S. Pat. No. 5,817,359—‘Methods for dealcoholization employing perstraction’, Outubro 1998;

WO 9954432—‘Process for producing and extracting aromatic compounds’, October 1999;

U.S. Pat. No. 6,162,360—‘Membrane process for making enhanced flavor fluids’, December 2000;

U.S. Pat. No. 6,287,618—‘Method of production of citrus concentrated aroma and method of preparation of flavorous composition or drink using the resulting flavorous component’, September 2001;

U.S. Pat. No. 6,419,829—‘Membrane process for making enhanced flavor fluids’, July 2002;

U.S. Pat. No. 6,518,050—‘Process for producing and extracting aromatic compounds’, February 2003;

U.S. Pat. No. 6,755,975—‘Separation process using pervaporation and dephlegmation’, June 2004;

PT 102976—‘Processo integrado de nanofiltraçāo para reduçāo do teor alcoólico de bebidas’, June 2004;

WO 2004/113489—‘Integrated nanofiltration to reduce the alcohol content of alcoholic beverages’, December 2004.

### OTHER REFERENCES

[1]—Pereira, C. C., Rufino, J. R. M., Habert, A. C., Nobrega, R., Cabral, L. M. C., Borges, C. P., ‘Aroma compounds recovery of tropical fruit juice by pervaporation: membrane material selection and process evaluation’, Journal of Food Engineering, 66, 77-87, 2005;

[2]—Karlsson, H. O. E., Trägårdh, G., ‘Aroma recovery during beverage processing’, Journal of Food Engineering, 34, 159-178, 1997;

[3]—Trifunovic, O., Trägårdh, G., ‘Transport of dilute volatile organic compounds through pervaporation membranes’, Desalination, 149, 1-2, 2002;

[4]—Tan, S., Li, L., Xiao, Z., Wu, Y., Zhang, Z., ‘Pervaporation of alcoholic beverages—the coupling effects between ethanol and aroma compounds’, Journal of Membrane Science, 264, 129-136, 2005;

[5]—Sampranpiboon, P., Jiraratananon, R., Uttapap, D., Feng, X., Huang, R. Y. M., ‘Pervaporation separation of ethyl butyrate and isopropanol with polyether block amide (PEBA) membranes’, Journal of Membrane Science, 173, 53-59, 2000;

[6]—Boerjesson, J., Karlsson, H. O. E., Trägårdh, G., ‘Pervaporation of a model apple juice aroma solution: comparison of membrane performance’, Journal of Membrane Science, 119, 229-239, 1996;

[7]—Pereira, C. C., Rufino, J. R. M., Habert, A. C., Nobrega, R., Cabral, L. M. C., Borges, C. P., ‘Membrane for processing tropical fruit juice’, Desalination 148, 57-60, 2002;

[8]—Lipnizki, F., Olsson, J., Trägårdh G., ‘Scale-up of pervaporation for the recovery of natural aroma compounds in the food industry. Part 1: Simulation and performance.’ Journal of Food Engineering, 54, 183-195, 2002;

[9]—Shepherd, A., Habert, A. C., Borges, C. P., ‘Hollow fibre modules for orange juice aroma recovery using pervaporation’, Desalination, 148, 111-114, 2002;

[10]—Jiraratananon, R., Sampranpiboon, P., Uttapap, D., Huang, R. Y. M., ‘Pervaporation separation and mass transport of ethylbutanoate solution by polyether block amide (PEBA) membranes’, Journal of Membrane Science, 210, 389-409, 2002;

[11]—Smitha, B., Suhanya, D., Sridhar, S., Ramakrishna, M., ‘Separation of organic-organic mixtures by pervaporation—a review’, Journal of Membrane Science, 241, 1-21, 2004;

[12]—Karlsson, H. O. E., Loureiro, S. Trägårdh, G., ‘Aroma compound recovery with pervaporation—temperature effects during pervaporation of a muscat wine’, Journal of Food Engineering, 26, 177-19, 1995.

1. A process to obtain beverages with an enriched/balanced aroma profile, comprising aroma extraction, by means of aroma pervaporation from the original beverage and subsequent addition of the aroma extract to the totally or partially dealcoholized beverage.

2. The process according to claim 1, further comprising:
obtaining a beverage stream from a storage tank, where the original beverage is present, and feeding it into a pervaporation unit;
establishing a feed temperature to pervaporation membranes modules, by means of a heat exchanger;
fractionating the feed stream at the pervaporation membrane modules;
recycling part of the fractioned feed stream (retentate) to the storage tank where a portion of the original beverage is still present;
feeding the remaining fraction of the retentate, that has not been recycled to the storage tank, into a dealcoholization unit;
condensing permeate vapor that left the membrane module; and
adding the aroma extract to the dealcoholized beverage.

3. The process according to claim 1, further comprising:
establishing a feed stream from a storage tank, where the original beer is present, into a pervaporation unit;
establishing a feed temperature to pervaporation membranes modules, by means of a heat exchanger;
fractionating the feed stream at the pervaporation membrane modules;
feeding the whole retentate current into a dealcoholization unit, without any recycling of the retentate current, which leaves the membrane modules of the pervaporation unit;
condensing vapor permeate that left the membrane modules; and
adding the aroma extract to the dealcoholized beverage.

4. The process according to claim 2, wherein the beverage is alcoholic, not exclusively being beer or wine.

5. The process according to claim 2, wherein permeation is carried out through composite polydimethylsiloxane (PDMS) membranes, comprising a selective film of 0.1 to 2 μm, or through a composite polyoctylmethylsiloxane (POMS) membranes with a 0.1 to 2 μm thick selective film.

6. The process according to claim 2, wherein permeation is carried out through composite polyoctylmethylsiloxane/polyetherimide (POMS/PEI) membranes, comprising a selective film of 0.1 to 2 μm.

7. The process according to claim 2, wherein condensation takes place at a temperature between 77 K and 193 K, permeate pressure is set between 100 Pa and 10 kPa, and operation temperature at the membrane modules being variable between 278 K to 313 K.

8. The process according to claim 2, wherein addition of the aromas to the dealcoholized beverage is carried out directly, by means of a dosing pump, which flow rate is in agreement with the desired aroma profile and the highest ethanol content that is admissible for the produced non-alcoholic beverage.

9. The process according to claim 3, wherein the beverage is alcoholic, not exclusively being beer or wine.

10. The process according to claim 3, wherein permeation is carried out through composite polydimethylsiloxane (PDMS) membranes, comprising a selective film of 0.1 to 2 μm, or through a composite polyoctylmethylsiloxane (POMS) membranes with a 0.1 to 2 μm thick selective film.

11. The process according to claim 3, wherein permeation is carried out through composite polyoctylmethylsiloxane/polyetherimide (POMS/PEI) membranes, comprising a selective film of 0.1 to 2 μm.

12. The process according to claim 3, wherein condensation takes place at a temperature between 77 K and 193 K, permeate pressure is set between 100 Pa and 10 kPa, and operation temperature at the membrane modules being variable between 278 K to 313 K.

13. The process according to claim 3, wherein addition of the aromas to the dealcoholized beverage is carried out directly, by means of a dosing pump, which flow rate is in agreement with the desired aroma profile and the highest ethanol content that is admissible for the produced non-alcoholic beverage.
